(19) United States
(12) Patent Application Publication
(10) Pub. No.: US 2021/0276914 A1
(43) Pub. Date: Sep. 9, 2021

(54) OPTICAL GLASS, OPTICAL ELEMENT, OPTICAL SYSTEM, INTERCHANGEABLE LENS, AND OPTICAL DEVICE

(71) Applicant: HIKARI GLASS CO., LTD., Yuzawa (JP)

(72) Inventors: Noriaki IGUCHI, Yokote-shi (JP); Miyuki ITO, Yokote-shi (JP); Kazuma OHTAKA, Yokote-shi (JP)

(73) Assignee: HIKARI GLASS CO., LTD., Yuzawa (JP)

(21) Appl. No.: 17/328,166

(22) Filed: May 24, 2021

Related U.S. Application Data
(63) Continuation of application No. PCT/JP2019/016925, filed on Apr. 22, 2019.

(30) Foreign Application Priority Data
Nov. 30, 2018 (JP) 2018-224548

(51) Int. Cl. C03C 3/21; C03C 3/066; C03C 3/068; C03C 3/064; G02B 1/00

(52) U.S. Cl. CPC C03C 3/21; C03C 3/066; G02B 1/00; C03C 3/064; C03C 3/068

(57) ABSTRACT

Provided is an optical glass including, by mass %, 24.5% to 41% of a P₂O₅ component, 6% to 17% of an Na₂O component, 5% to 15% of a K₂O component, over 0% to 7% or less of an Al₂O₃ component, 8% to 21% of a TiO₂ component, and 5% to 38% of an Nb₂O₅ content, and the optical glass has a partial dispersion ratio (P_{g, F}) of 0.634 or less.

### CROSS-REFERENCE TO RELATED APPLICATIONS

This application is a continuation of International Application PCT/JP2019/016925, filed on Apr. 22, 2019, and claims priority to Japanese Patent Application No. 2018-224548, filed on Nov. 30, 2018, the contents of which are incorporated by reference herein in their entireties in designated states where the incorporation of documents by reference is approved.

### TECHNICAL FIELD

The present invention relates to an optical glass, an optical element, an optical system, an interchangeable lens, and an optical device.

### BACKGROUND ART

For example, an optical glass described in Patent Literature 1 has been known as an optical glass that can be used in imaging equipment and the like. In recent years, imaging equipment and the like including an image sensor with a large number of pixels have been developed, and an optical glass that is highly dispersive and low specific gravity has been demanded as an optical glass to be used for such equipment.

Patent Literature 1: JP 2006-219365 A

### SUMMARY

A first aspect according to the present invention is an optical glass including, by mass %, 24.5% to 41% of a P₂O₅ content, 6% to 17% of an Na₂O content, 5% to 15% of a K₂O content, over 0% to 7% or less of an Al₂O₃ content, 8% to 21% of a TiO₂ content, and 5% to 38% of an Nb₂O₅ content, and the optical glass has a partial dispersion ratio (P_{g, F}) of 0.634 or less.

A second aspect according to the present invention is an optical element using the optical glass described above.

A third aspect according to the present invention is an optical system including the optical element described above.

A fourth aspect according to the present invention is an interchangeable lens including the optical system described above.

A fifth aspect according to the present invention is an optical device including the optical system described above.

### BRIEF DESCRIPTION OF DRAWINGS

FIG. 1 is a perspective view of an imaging device including an optical element using an optical glass according to the present embodiment.

FIG. 2 is a front view of another example of the imaging device including the optical element using the optical glass according to the present embodiment.

FIG. 3 is a back view of the imaging device in FIG. 2.

FIG. 4 is a block diagram illustrating an example of a configuration of a multi-photon microscope according to the present embodiment.

FIG. 5 is a graph obtained by plotting an optical constant value in each example.

### DETAILED DESCRIPTION

Hereinafter, description is made on an embodiment of the present invention (hereinafter, referred to as the “present embodiment”). The present embodiment described below is an example for describing the present invention, and is not intended to limit the present invention to the contents described below. The present invention may be modified as appropriate and carried out without departing from the gist thereof.

In the present specification, a content amount of each of all the components is expressed with mass % (mass percentage) with respect to the total weight of glass in terms of an oxide-converted composition unless otherwise stated. Assuming that oxides, complex salt, and the like, which are used as raw materials as glass constituent components in the present embodiment, are all decomposed and turned into oxides at the time of melting, the oxide-converted composition described herein is a composition in which each component contained in the glass is expressed with a total mass of the oxides as 100 mass %.

The optical glass according to the present embodiment is an optical glass including, by mass %, 24.5% to 41% of a P₂O₅ component, 6% to 17% of an Na₂O component, 5% to 15% of a K₂O component, over 0% to 7% or less of an Al₂O₃ component, 8% to 21% of a TiO₂ component, and 5% to 38% of an Nb₂O₅ component, and has a partial dispersion ratio (P_{g, F}) of 0.634 or less.

Hitherto, a method of increasing a content amount of a component such as TiO₂ and Nb₂O₅ has been attempted in order to achieve high dispersion. However, when the content amounts of those are increased, reduction of a transmittance and increase of specific gravity are liable to be caused. At this viewpoint, the optical glass according to the present embodiment can be highly dispersive and can be reduced in specific gravity. Thus, a light-weighted lens can be achieved.

First, description is made on each component of the optical glass according to the present embodiment.

P₂O₅ is a component that forms a glass frame, improves devitrification resistance, reduces a refractive index, and degrades chemical durability. When the content amount of P₂O₅ is excessively reduced, devitrification is liable to be caused. When the content amount of P₂O₅ is excessively increased, a refractive index is liable to be reduced, and chemical durability is liable to be degraded. From such viewpoint, the content amount of P₂O₅ is 24.5% or more and 41% or less. The lower limit of the content amount is preferably 25% or more, more preferably, 28% or more, and the upper limit of the content amount is preferably 40% or less, more preferably, 37% or less. When the content amount of P₂O₅ falls within such range, devitrification resistance can be improved, chemical durability can be satisfactory, and a refractive index can be increased.

Na₂O is a component that improves meltability and degrades chemical durability. When the content amount of Na₂O is excessively reduced, meltability is liable to be degraded. From such viewpoint, the content amount of Na₂O is 6% or more and 17% or less. The lower limit of the content amount is preferably 7% or more, more preferably, 8% or more, and the upper limit of the content amount is preferably 15% or less, more preferably, 14% or less.

K₂O is a component that improves meltability and degrades chemical durability. When the content amount of K₂O is excessively reduced, meltability is liable to be degraded. From such viewpoint, the content amount of K₂O is 5% or more and 15% or less. The lower limit of the content amount is preferably 6% or more, more preferably, 7% or more, and the upper limit of the content amount is preferably 13% or less, more preferably, 12% or less.

Al₂O₃ is a component that improves chemical durability but degrades devitrification resistance. When the content amount of Al₂O₃ is excessively reduced, chemical durability is liable to be degraded. From such viewpoint, the content amount of Al₂O₃ is over 0% to 7% or less. The lower limit of the content amount is preferably 0.5% or more, more preferably, 1% or more, and the upper limit of the content amount is preferably 6.5% or less, more preferably, 5% or less, further more preferably, 4% or less.

TiO₂ is a component that increases a refractive index and reduces a transmittance. When the content amount of TiO₂ is increased, a transmittance is liable to be degraded. From such viewpoint, the content amount of TiO₂ is 8% or more and 21% or less. The lower limit of the content amount is preferably 9% or more, more preferably, 10% or more, and the upper limit of the content amount is preferably 20% or less, more preferably, 19.5% or less, further more preferably, 19% or less.

Nb₂O₅ is a component that increases a refractive index, improves dispersion, and reduces a transmittance. When the content amount of Nb₂O₅ is reduced, a refractive index is liable to be reduced. When the content amount of Nb₂O₅ is increased, a transmittance is liable to be degraded. From such viewpoint, the content amount of Nb₂O₅ is 5% or more and 38% or less. The lower limit of the content amount is preferably 6% or more, more preferably, 7% or more, and the upper limit of the content amount is preferably 36% or less, more preferably, 34% or less.

Further, the optical glass according to the present embodiment may further include one or more kinds selected from a group consisting of SiO₂, B₂O₃, Bi₂O₃, MgO, Li₂O, CaO, BaO, SrO, ZnO, ZrO₂, Y₂O₃, La₂O₃, Gd₂O₃, WO₃, and Sb₂O₃.

SiO₂ is a component that is effective in adjusting a constant value. From a viewpoint of further improving devitrification resistance, the upper limit of the content amount is preferably 3.5% or less, more preferably, 2% or less.

B₂O₃ is a component that is effective in adjusting a constant value. From a viewpoint of further improving devitrification resistance, the upper limit of the content amount is preferably 10% or less, more preferably, 7% or less.

Bi₂O₃ is a component that is effective in improving devitrification resistance, but is a component that degrades transmittance performance. From a view point of preventing degradation of transmittance performance, the upper limit of the content amount is preferably 5% or less, more preferably, 3% or less.

MgO is a component that is effective in increasing a refractive index. From a viewpoint of further improving devitrification resistance, the upper limit of the content amount is preferably 2% or less.

Li₂O is a component that improves meltability and increases a refractive index. From a viewpoint of further improving devitrification resistance, the upper limit of the content amount is preferably 3.5% or less, more preferably, 2% or less.

CaO is a component that is effective in increasing a refractive index. From a viewpoint of further improving devitrification resistance, the upper limit of the content amount is preferably 9.5% or less, more preferably, 8% or less.

BaO is a component that is effective in increasing a refractive index. From a viewpoint of further improving devitrification resistance, the upper limit of the content amount is preferably 9% or less, more preferably, 8.5% or less.

The SrO component is a component that is effective in increasing a refractive index. From a viewpoint of further improving devitrification resistance, the upper limit of the content amount is preferably 1.5% or less, more preferably, 0.5% or less.

ZnO is a component that is effective in increases a refractive index and achieves high dispersion. From a viewpoint of further improving devitrification resistance, the upper limit of the content amount is preferably 5% or less, more preferably, 4% or less.

ZrO₂ is a component that is effective in increasing a refractive index and achieving high dispersion. From a viewpoint of further improving devitrification resistance, the upper limit of the content amount is preferably 6% or less, more preferably, 4% or less.

Y₂O₃ is a component that is effective in increasing a refractive index. From a viewpoint of further improving devitrification resistance, the upper limit of the content amount is preferably 1.5% or less, more preferably, 0.5% or less.

La₂O₃ is a component that is effective in increasing a refractive index. From a viewpoint of further improving devitrification resistance, the upper limit of the content amount is preferably 1.5% or less, more preferably, 0.5% or less.

Gd₂O₃ is a component that is effective in increasing a refractive index. From a viewpoint of further improving devitrification resistance, the upper limit of the content amount is preferably 2% or less, more preferably, 0.5% or less.

WO₃ is a component that is effective in increasing a refractive index and achieving high dispersion, but is an expensive raw material. Thus, the upper limit of the content amount is preferably 3% or less, more preferably, 2% or less.

Sb₂O₃ is effective as a defoaming agent. However, when the content amount exceeds a certain amount, transmittance performance is degraded. For the purpose of improving transmittance performance of the glass, the upper limit of the content amount is preferably 0.4% or less, more preferably, 0.2% or less.

The optical glass according to the present embodiment enables a content amount of Ta₂O₅ or the like being an expensive raw material to be reduced, and further enables such material to be excluded. Thus, the optical glass according to the present embodiment is also excellent in reduction of raw material cost.

A suitable combination of those components includes 0% to 3.5% of an SiO₂ component, 0% to 10% of a B₂O₃ component, 0% to 5% of a Bi₂O₃ component, 0% to 2% of an MgO component, 0% to 3.5% of an Li₂O component, 0% to 9.5% of a CaO component, 0% to 9% of a BaO component, 0% to 1.5% of an SrO component, 0% to 5% of a ZnO component, 0% to 6% of a ZrO₂ component, 0% to 1.5% of a Y₂O₃ component, 0% to 1.5% of an La₂O₃ component, 0% to 2% of a Gd₂O₃ component, 0% to 3% of a WO₃ component, and 0% to 0.4% of an Sb₂O₃ component.

In addition, regarding combinations and ratios of the components, suitable examples are further given below.

The sum of the content amounts of P₂O₅ and B₂O₃ (P₂O₅+B₂O₃) is preferably from 28% to 43%. Further, the lower limit of the sum of the content amounts is more preferably 30% or more, and the upper limit of the sum of the content amounts is more preferably 39%. When P₂O₅+B₂O₃ falls within such range, a refractive index can be increased.

The ratio of B₂O₃ to P₂O₅ (B₂O₃/P₂O⁵) is preferably 0 or more and 0.24 or less. Further, the lower limit of the ratio is more preferably 0.015 or more, and the upper limit of the ratio is more preferably 0.21 or less. When B₂O₃/P₂O₅ falls within such range, devitrification resistances can be improved, and a refractive index can be increased.

The ratio of TiO₂ to P₂O₅ (TiO₂/P₂O₅) is preferably 0.3 or more and 0.7 or less. Further, the lower limit of the ratio is more preferably 0.4 or more, and the upper limit of the ratio is more preferably 0.6 or less. When TiO₂/P₂O₅ falls within such range, devitrification resistance can be improved, and a refractive index can be increased.

The ratio of Nb₂O₅ of P₂O₅ (Nb₂O₅/P₂O₅) is preferably 0.1 or more and 1.3 or less. Further, the lower limit of the ratio is more preferably 0.2 or more, and the upper limit of the ratio is more preferably 1.2 or less. When Nb₂O₅/P₂O₅ falls within such range, a refractive index can be increased.

The sum of the content amounts of Li₂O, Na₂O, and K₂O (Li₂O+Na₂O+K₂O) is preferably 14% or more and 25% or less. Further, the lower limit of the sum of the content amounts is more preferably 15% or more, and the upper limit of the sum of the content amounts is more preferably 23% or less. When Li₂O+Na₂O+K₂O falls within such range, meltability can be improved without degrading chemical durability.

Note that, for the purpose of, for example, performing fine adjustments of fining, coloration, decoloration, and optical constant values, a known component such as a fining agent, a coloring agent, a defoaming agent, and a fluorine compound may be added by an appropriate amount to the glass composition as needed. In addition to the above-mentioned components, other components may be added as long as the effect of the optical glass according to the present embodiment can be exerted.

A method of manufacturing the optical glass according to the present embodiment is not particularly limited, and a publicly known method may be adopted. Further, suitably conditions can be selected for the manufacturing conditions as appropriate. As one of the suitable examples, there is exemplified a method including a step of selecting, as glass raw material, one from oxides, hydroxides, phosphate compounds (phosphates, orthophosphoric acids, and the like), carbonates, nitrates, and the like, which corresponds to each of the raw materials described above, mixing those materials, melting those materials at a temperature from 1,100 degrees Celsius to 1,400 degrees Celsius, and performing uniformization by stirring, and then cooling to mold.

More specifically, there may be adopted a manufacturing method in which raw materials such as oxides, carbonates, nitrates, and sulfates are blended to obtain a target composition, melted at a temperature preferably from 1,100 degrees Celsius to 1,400 degrees Celsius, more preferably from 1,100 degrees Celsius to 1,300 degrees Celsius, further more preferably from 1,100 degrees Celsius to 1,250 degrees Celsius, uniformed by stirring, subjected to defoaming, then poured in a mold to be molded. The optical glass thus obtained is processed to have a desired shape by performing re-heat pressing or the like as needed, and is subjected to polishing. With this, a desired optical glass and a desired optical element can be obtained.

The composition of the optical glass according to the present embodiment is easily melted. Thus, it is easy to perform uniformization by stirring, and excellent production efficiency is achieved. Specifically, when 50 g of the raw materials of the optical glass are heated at a temperature from 1,100 degrees Celsius to 1,250 degrees Celsius, the time period required for melting the raw materials is preferably less than 15 minutes, more preferably 13 minutes or less, further more preferably, 10 minutes or less. The “time period required for melting” referred to herein indicates a time period from when heating and holding is started for the raw materials required for forming the optical glass, to when the raw materials cannot be visually recognized near a liquid surface due those raw materials being melted.

The glass raw materials are melted for the short time period as described above, at a temperature range from 1,100 degrees Celsius to 1,250 degrees Celsius. Thus, the remaining glass raw materials can be prevented from mixing into the glass. Further, when heating is performed at a high temperature, or heating and holding are performed for a long time period for the purpose of forcefully melting the remaining glass raw materials, this may cause degradation of glass production efficiency or degradation of transmittance. However, according to the present embodiment, such defect is not caused.

A high-purity material with a small content amount of impurities is preferably used as the raw material. The high-purity material indicates a material including 99.85 mass % or more of a concerned component. By using the high-purity material, an amount of impurities is reduced, and hence an inner transmittance of the optical glass is likely to be increased.

Next, description is made on various physical properties of the optical glass according to the present embodiment.

The optical glass according to the present embodiment has a partial dispersion ratio (P_{g, F}) of 0.634 or less. The optical glass according to the present embodiment achieves a large partial dispersion ratio (P_{g, F}), and hence is effective in aberration correction of a lens. From such viewpoint, the lower limit of the partial dispersion ratio (P_{g, F}) of the optical glass according to the present embodiment is preferably 0.6 or more, more preferably, 0.610 or more. Further, the upper limit of the partial dispersion ratio (P_{g, F}) is more preferably 0.632 or less.

From a viewpoint of reducing a thickness of the lens, the optical glass according to the present embodiment preferably has a high refractive index (a refractive index (n_{d}) is large). However, in general, as the refractive index is higher, the specific gravity is liable to be increased. In view of such circumstance, the refractive index (n_{d}) of the optical glass according to the present embodiment with respect to a d-line preferably falls within a range from 1.66 to 1.81. Further, the lower limit of the refractive index (n_{d}) is more preferably 1.67 or more, and the upper limit of the refractive index (n_{d}) is more preferably 1.80 or less.

An abbe number (ν_{d}) of the optical glass according to the present embodiment preferably falls within a range from 22 to 32. Further, the lower limit of the abbe number (ν_{d}) is more preferably 23 or more, further more preferably 24 or more, and the upper limit of the abbe number (ν_{d}) is more preferably 29 or less, further more preferably, 28 or less.

With regard to the optical glass according to the present embodiment, a preferably combination of the refractive index (n_{d}) and the abbe number (ν_{d}) is the refractive index (n_{d}) falling within a range from 1.66 to 1.81 and the abbe number (ν_{d}) falling within a range from 22 to 32. An optical system in which chromatic aberrations and other aberrations are satisfactorily corrected can be designed by, for example, combining the optical glass according to the present embodiment having such properties with other optical glasses and using the combination as a convex lens in a concave lens group.

From a viewpoint of reducing a weight of the lens, the optical glass according to the present embodiment preferably has low specific gravity. However, in general, as the specific gravity is reduced, a refractive index is liable to be reduced. In view of such circumstance, suitable specific gravity of the optical glass according to the present embodiment falls within a range with a lower limit of 2.8 and an upper limit of 3.4, i.e., from 2.8 to 3.4.

A value (ΔP_{g, F}) indicating abnormal dispersibility is preferably from 0.0190 to 0.0320. The upper limit is more preferably 0.0315 or less, further more preferably, 0.0310 or less, and the lower limit is more preferably 0.0200 or more, and further more preferably, 0.0210 or more. ΔP_{g, F} is an index indicating abnormal dispersibility, and can be obtained in accordance with a method described in Examples given later.

From the viewpoint described above, the optical glass according to the present embodiment achieves reduced raw material cost, low specific gravity, and high dispersion (that is, the abbe number (ν_{d}) is small). The value (ΔP_{g, F}) indicating abnormal dispersibility and the partial dispersion ratio P_{g, F} can also be increased. The optical glass according to the present embodiment is suitable as an optical element such as a lens included in an optical device such as a camera and a microscope. Such optical element includes a mirror, a lens, a prism, a filter, and the like. Examples of the optical system including such optical element includes an objective lens, a condensing lens, an image forming lens, an interchangeable lens for a camera, and the like. Such optical system can be used in an imaging device such as a lens-interchangeable camera and a fixed lens camera, and a microscope such as a multi-photon microscope. Note that, not limited to the imaging device and the microscope described above, examples of the optical device include a video camera, a teleconverter, a telescope, a binocular telescope, a monocular telescope, a laser range finder, a projector, and the like. One example of those is described below.

### <Imaging Device>

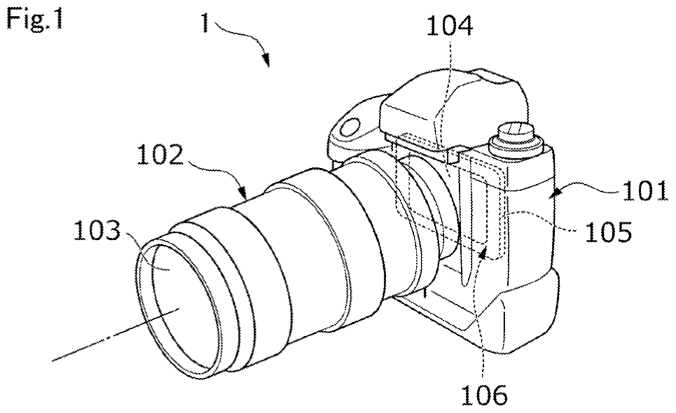

FIG. 1 is a perspective view of an imaging device including an optical element using the optical glass according to the present embodiment.

An imaging device 1 is a so-called digital single-lens reflex camera (a lens-interchangeable camera), and a photographing lens 103 (an optical system) includes, as a base material, an optical element including the optical glass according to the present embodiment. A lens barrel 102 is mounted to a lens mount (not illustrated) of a camera body 101 in a removable manner. Further, an image is formed with light, which passes through the lens 103 of the lens barrel 102, on a sensor chip (solid-state imaging elements) 104 of a multi-chip module 106 arranged on a back surface side of the camera body 101. The sensor chip 104 is a so-called bare chip such as a CMOS image sensor, and the multi-chip module 106 is, for example, a Chip On Glass (COG) type module including the sensor chip 104 being a bare chip mounted on a glass substrate 105.

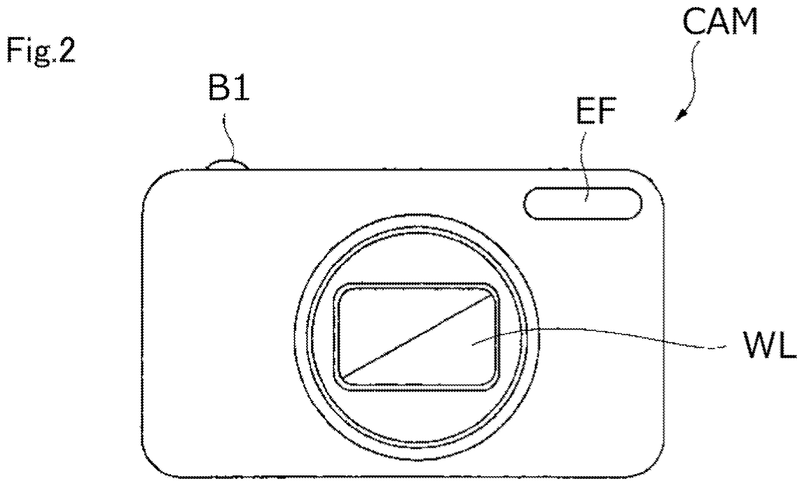

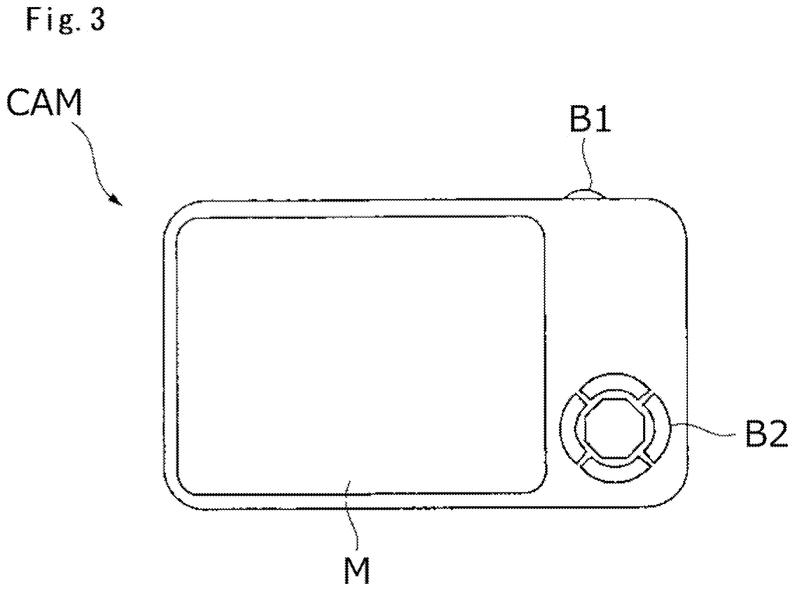

FIG. 2 is a front view of another example of the imaging device including the optical element using the optical glass according to the present embodiment, and FIG. 3 is a back view of the imaging device in FIG. 2.

The imaging device CAM is a so-called digital still camera (a fixed lens camera), and a photographing lens WL (an optical system) includes an optical element including the optical glass according to the present embodiment, as a base material.

When a power button (not illustrated) of the imaging device CAM is pressed, a shutter (not illustrated) of the photographing lens WL is opened, light from an object to be imaged (a body) is converged by the photographing lens WL and forms an image on imaging elements arranged on an image surface. An object image formed on the imaging elements is displayed on a liquid crystal monitor LM arranged on the back of the imaging device CAM. A photographer decides composition of the object image while viewing the liquid crystal monitor LM, then presses down a release button B1, and captures the object image on the imaging elements. The object image is recorded and stored in a memory (not illustrated).

An auxiliary light emitting unit EF that emits auxiliary light in a case that the object is dark and a function button B2 to be used for setting various conditions of the imaging device CAM and the like are arranged on the imaging device CAM.

A higher resolution, lighter weight, and a smaller size are demanded for the optical system to be used in such digital camera or the like. In order to achieve such demands, it is effective to use glass with a high refractive index as the optical system. Particularly, glass that achieves both a high refractive index and lower specific gravity (S_{g}) and has high press formability is highly demanded. From such viewpoint, the optical glass according to the present embodiment is suitable as a member of such optical equipment. Note that, in addition to the imaging device described above, examples of the optical equipment to which the present embodiment is applicable include a projector and the like. In addition to the lens, examples of the optical element include a prism and the like.

### <Multi-Photon Microscope>

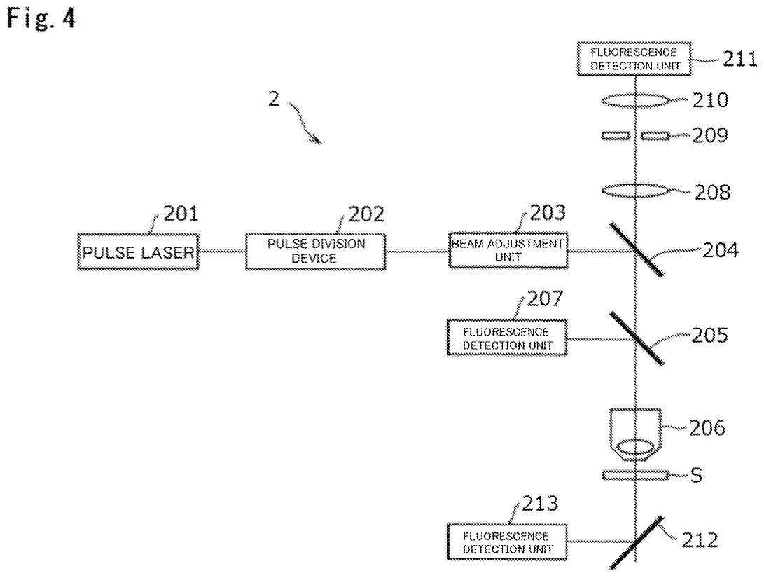

FIG. 4 is a block diagram illustrating an example of a configuration of a multi-photon microscope 2 including the optical element using the optical glass according to the present embodiment.

The multi-photon microscope 2 includes an objective lens 206, a condensing lens 208, and an image forming lens 210. At least one of the objective lens 206, the condensing lens 208, and the image forming lens 210 includes an optical element including, as a base material, the optical glass according to the present embodiment. Hereinafter, description is mainly made on the optical system of the multi-photon microscope 2.

A pulse laser device 201 emits ultrashort pulse light having, for example, a near infrared wavelength (approximately 1,000 nm) and a pulse width of a femtosecond unit (for example, 100 femtoseconds). In general, ultrashort pulse light immediately after being emitted from the pulse laser device 201 is linearly polarized light that is polarized in a predetermined direction.

A pulse division device 202 divides the ultrashort pulse light, increases a repetition frequency of the ultrashort pulse light, and emits the ultrashort pulse light.

A beam adjustment unit 203 has a function of adjusting a beam diameter of the ultrashort pulse light, which enters from the pulse division device 202, to a pupil diameter of the objective lens 206, a function of adjusting convergence and divergence angles of the ultrashort pulse light in order to correct chromatic aberration (a focus difference) on an axis of a wavelength of multi-photon excitation light emitted from a sample S and the wavelength of the ultrashort pulse light, a pre-chirp function (group velocity dispersion compensation function) providing inverse group velocity dispersion to the ultrashort pulse light in order to correct the pulse width of the ultrashort pulse light, which is increased due to group velocity dispersion at the time of passing through the optical system, and the like.

The ultrashort pulse light emitted from the pulse laser device 201 have a repetition frequency increased by the pulse division device 202, and is subjected to the above-mentioned adjustments by the beam adjustment unit 203. Furthermore, the ultrashort pulse light emitted from the beam adjustment unit 203 is reflected on a dichroic mirror 204 in a direction toward a dichroic mirror, passes through a dichroic mirror 205, is converged by the objective lens 206, and is radiated to the sample S. At this time, an observation surface of the sample S may be scanned with the ultrashort pulse light through use of scanning means (not illustrated).

For example, when the sample S is subjected to fluorescence imaging, a fluorescent pigment by which the sample S is dyed is subjected to multi-photon excitation in an irradiated region with the ultrashort pulse light and the vicinity thereof on the sample S, and fluorescence having a wavelength shorter than a infrared wavelength of the ultrashort pulse light (hereinafter, also referred to “observation light”) is emitted.

The observation light emitted from the sample S in a direction toward the objective lens 206 is collimated by the objective lens 206, and is reflected on the dichroic mirror 205 or passes through the dichroic mirror 205 depending on the wavelength.

The observation light reflected on the dichroic mirror 205 enters a fluorescence detection unit 207. For example, the fluorescence detection unit 207 is formed of a barrier filter, a photo multiplier tube (PMT), or the like, receives the observation light reflected on the dichroic mirror 205, and outputs an electronic signal depending on an amount of the light. The fluorescence detection unit 207 detects the observation light over the observation surface of the sample S, in conformity with the ultrashort pulse light scanning on the observation surface of the sample S.

Meanwhile, the observation light passing through the dichroic mirror 205 is de-scanned by scanning means (not illustrated), passes through the dichroic mirror 204, is converged by the condensing lens 208, passes through a pinhole 209 provided at a position substantially conjugate to a focal position of the objective lens 206, passes through the image forming lens 210, and enters a fluorescence detection unit 211.

For example, the fluorescence detection unit 211 is formed of a barrier filter, a PMT, or the like, receives the observation light forming an image on a light receiving surface of the fluorescence detection unit 211 by the image forming lens 210, and outputs an electronic signal depending on an amount of the light. Further, the fluorescence detection unit 211 detects the observation light over the observation surface of the sample S, in conformity with the ultrashort pulse light scanning on the observation surface of the sample S.

Note that, all the observation light emitted from the sample S in a direction toward the objective lens 206 may be detected by the fluorescence detection unit 211 by excluding the dichroic mirror 205 from the optical path.

The observation light emitted from the sample S in a direction opposite to the objective lens 206 is reflected on a dichroic mirror 212, and enters a fluorescence detection unit 213. The fluorescence detection unit 213 is formed of, for example, a barrier filter, a PMT, or the like, receives the observation light reflected on the dichroic mirror 212, and outputs an electronic signal depending on an amount of the light. Further, the fluorescence detection unit 213 detects the observation light over the observation surface of the sample S, in conformity with the ultrashort pulse light scanning on the observation surface of the sample S.

The electronic signals output from the fluorescence detection units 207, 211, and 213 are input to, for example, a computer (not illustrated). The computer is capable of generating an observation image, displaying the generated observation image, storing data on the observation image, based on the input electronic signals.

### EXAMPLES

Next, description is made on Examples and Comparative Examples given below, but the present invention is not limited by the following examples at all.

### <Production of Optical Glasses>

The optical glasses in each of the Examples and the Comparative Examples were produced by the following procedures. First, glass raw materials selected from oxides, hydroxides, phosphate compounds (phosphates, orthophosphoric acids, and the like), carbonates, nitrates, and the like were weighed so as to obtain the compositions (mass %) illustrated in each table. Next, the weighed raw materials were mixed and put in a platinum crucible, melted at a temperature from 1,100 degrees Celsius to 1,300 degrees Celsius for 70 minutes, and uniformed by stirring. After defoaming, the resultant was lowered to an appropriate temperature, poured in a mold, annealed, and molded. In this manner, each sample was obtained.

1. Refractive Index (n_{d}) and Abbe Number (ν_{d})

The refractive index (n_{d}) and the abbe number (ν_{d}) in each of the samples were measured and calculated through use of a refractive index measuring instrument (KPR-2000 manufactured by Shimadzu Device Corporation). n_{d} indicates a refractive index of the glass with respect to light of the d-line (a wavelength of 587.562 nm). ν_{d} was obtained based on Expression (1) given below. n_{c} and n_{F} indicate refractive indexes of the glass with respect to a C-line (having a wavelength of 656.273 nm) and an F-line (having a wavelength of 486.133 nm), respectively.

ν_{d}=(n_{d}−1)/(n_{F}−n_{c}) (1)

### 2. Partial Dispersion Ratio (P_{g, F})

The partial dispersion ratio (P_{g, F}) in each of the samples indicates a ratio of partial dispersion (n_{g}−n_{F}) to main dispersion (n_{F}−n_{c}), and was obtained based on Expression (2) given below. n_{g} indicates a refractive index of the glass with respect to a g-line (having a wavelength of 435.835 nm).

P_{g, F}=(n_{g}−n_{F})/(n_{F}−n_{c}) (2)

### 3. Value (ΔP_{g, F}) Indicating Abnormal Dispersibility

The value (ΔP_{g, F}) indicating abnormal dispersibility in each of the samples was obtained in accordance with the method described below.

### (1) Formation of Reference Line

First, as normally partial dispersion glasses, two glasses “F2” and “K7” having abbe numbers (ν_{d}) and partial dispersion ratios (P_{g, F}) given below were used as reference materials. Subsequently, for each glass, the horizontal axis indicates the abbe number (ν_{d}), the vertical axis indicates the partial dispersion ratio (P_{g, F}), and a linear line connecting two points corresponding to the two reference materials is set as a reference line.

Properties of glass “F2”: ν_{d}=36.33, P_{g, F}=0.5834

Properties of glass “K7”: ν_{d}=60.47, P_{g, F}=0.5429

### (2) Calculation of ΔP_{g, F}

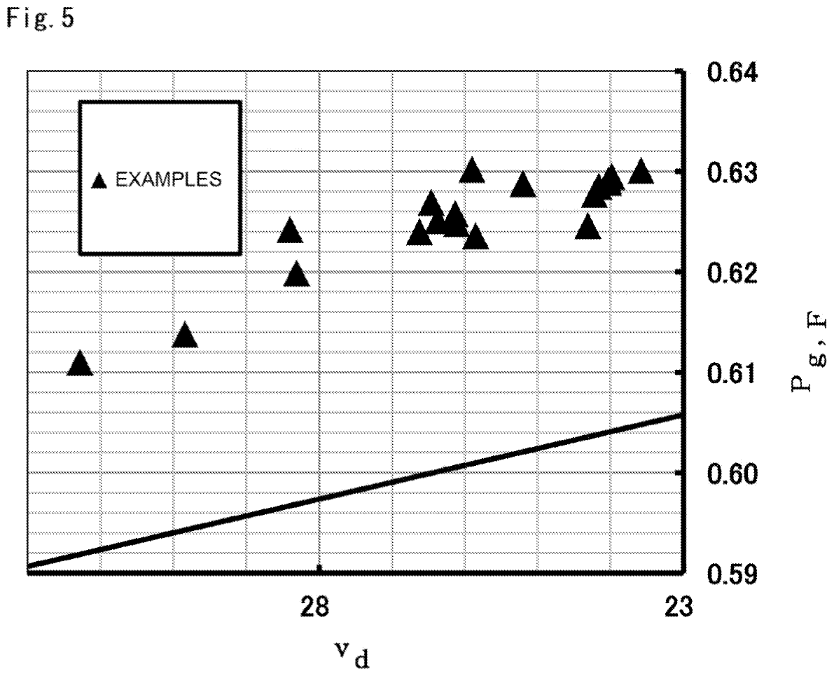

Subsequently, values corresponding to the optical glasses in each of the Examples were plotted on the graph with the horizontal axis indicating the abbe number (ν_{d}) and the vertical axis indicating the partial dispersion ratio (P_{g, F}) (see FIG. 5), and a difference between a point on the reference line corresponding to the abbe number (ν_{d}) of each glass type described above and the corresponding value (P_{g, F}) on the vertical axis was calculated as the value (ΔP_{g, F}) indicating abnormal dispersibility. Note that, when the partial dispersion ratio (P_{g, F}) was on the upper side with respect to the reference line, ΔP_{g, F} had a positive value, and when the partial dispersion ratio (P_{g, F}) was on the lower side with respect to the reference line, ΔP_{g, F} had a negative value.

### 4. Specific Gravity (S_{g})

The specific gravity (S_{g}) in each of the samples was obtained based on a mass ratio with respect to pure water having the same volume at 4 degrees Celsius.

### 5. Time Period Required for Melting Glass Raw Materials

The time period required for melting the glass raw materials indicate a time period from when 50 g of the glass raw materials were sufficiently mixed and put in a platinum crucible and heating and holding were started at a temperature from 1,100 degrees Celsius to 1,250 degrees Celsius, to when the glass raw materials were melted. In the Examples, it was determined that the glass raw materials were melted when an unmelted residue of the glass raw materials was not visually recognized at a glass liquid surface in the platinum crucible.

Each of the tables show compositions and physical properties in each of the Examples and the Comparative Examples. Note that a content amount of each component is in a mass % basis, unless otherwise specified.

FIG. 5 is a graph obtained by plotting optical constant values in each of the Examples.

TABLE 1

| | Example 1 | Example 2 | Example 3 | Example 4 | Example 5 |
|---|---|---|---|---|---|
| SiO₂ | 1.43 | 0.43 | 1.22 | 1.58 | 2.02 |
| P₂O₅ | 39.53 | 33.66 | 31.14 | 35.60 | 34.21 |
| B₂O₃ | 2.22 | 3.98 | 2.34 | 3.07 | 3.93 |
| Li₂O | | | | | |
| Na₂O | 11.39 | 8.34 | 12.28 | 13.22 | 12.32 |
| K₂O | 10.72 | 14.13 | 12.36 | 7.50 | 7.08 |
| BaO | | 5.75 | 4.68 | 5.72 | 5.99 |
| ZnO | 0.99 | 1.02 | 1.33 | 1.23 | 0.78 |
| Al₂O₃ | 1.38 | 1.47 | 1.38 | 1.22 | 1.03 |
| TiO₂ | 13.43 | 10.59 | 19.29 | 18.03 | 16.24 |
| Nb₂O₅ | 13.79 | 17.15 | 12.94 | 12.76 | 16.34 |
| ZrO₂ | 5.07 | | | | |
| MgO | | 1.50 | | | |
| CaO | | | | | |
| SrO | | 0.36 | | | |
| Y₂O₃ | | | | | |
| La₂O₃ | | | 1.04 | | |
| Gd₂O₃ | | | | | |
| WO₃ | | 1.52 | | | |
| Sb₂O₃ | 0.05 | 0.10 | | 0.07 | 0.06 |
| Total | 100 | 100 | 100 | 100 | 100 |
| P₂O₅ + B₂O₃ | 41.75 | 37.64 | 33.48 | 38.67 | 38.14 |
| B₂O₃/P₂O₅ | 0.056160 | 0.118241 | 0.075145 | 0.086236 | 0.114879 |
| TiO₂/P₂O₅ | 0.339742 | 0.314617 | 0.619461 | 0.506461 | 0.474715 |
| Nb₂O₅/P₂O₅ | 0.348849 | 0.509507 | 0.415543 | 0.358427 | 0.477638 |
| Li₂O + Na₂O +K₂O | 22.11 | 22.47 | 24.64 | 20.72 | 19.40 |
| n_{d} | 1.672788 | 1.675128 | 1.707471 | 1.708975 | 1.715403 |
| ν_{d} | 28.31 | 29.84 | 26.62 | 26.37 | 26.46 |
| P_{g,F} | 0.6199 | 0.6138 | 0.6240 | 0.6251 | 0.6269 |
| [symbol] P_{g,F} | 0.0230 | 0.0195 | 0.0243 | 0.0250 | 0.0270 |
| S_{g} | 2.91 | 3.06 | 3.06 | 3.06 | 3.10 |
| Time period required | Less than | Less than | Less than | Less than | Less than |
| for melting glass | 15 minutes | 15 minutes | 15 minutes | 15 minutes | 15 minutes |
| raw materials | | | | | |

TABLE 2

| | Example 6 | Example 7 | Example 8 | Example 9 | Example 10 |
|---|---|---|---|---|---|
| SiO₂ | 2.05 | 2.27 | 2.22 | 2.02 | 0.21 |
| P₂O₅ | 33.48 | 32.84 | 26.88 | 32.92 | 40.01 |
| B₂O₃ | 4.01 | 4.42 | 4.37 | 3.92 | 2.24 |
| Li₂O | | | | | |
| Na₂O | 11.95 | 11.53 | 13.75 | 12.29 | 15.83 |
| K₂O | 7.22 | 7.02 | 7.87 | 6.26 | 6.49 |
| BaO | 6.11 | 6.24 | 6.67 | 5.98 | |
| ZnO | 0.80 | 0.59 | 0.87 | 0.78 | 0.50 |
| Al₂O₃ | 1.05 | 0.96 | 1.14 | 1.03 | 1.26 |
| TiO₂ | 16.57 | 15.70 | 18.04 | 18.20 | 15.10 |
| Nb₂O₆ | 16.67 | 18.37 | 18.13 | 16.30 | 9.59 |
| ZrO₂ | | | | | |
| MgO | | | | | |
| CaO | | | | | 8.77 |
| Y₂O₃ | | | | | |
| La₂O₃ | | | | | |
| Gd₂O₃ | | | | | |
| WO₃ | | | | | |
| Sb₂O₃ | 0.09 | 0.06 | 0.06 | 0.30 | |
| Total | 100 | 100 | 100 | 100 | 100 |
| P₂O₅ + B₂O₃ | 37.49 | 37.26 | 31.25 | 36.84 | 42.25 |
| B₂O₃/P₂O₅ | 0.119773 | 0.134592 | 0.162574 | 0.119077 | 0.055986 |
| TiO₂/P₂O₅ | 0.494922 | 0.478076 | 0.671131 | 0.552855 | 0.377406 |
| Nb₂O₅/P₂O₅ | 0.497909 | 0.559379 | 0.674479 | 0.495140 | 0.239690 |
| Li₂O + Na₂O +K₂O | 19.17 | 18.55 | 21.62 | 18.55 | 22.32 |
| n_{d} | 1.720277 | 1.723633 | 1.731707 | 1.734510 | 1.663389 |
| ν_{d} | 26.13 | 26.11 | 25.85 | 25.20 | 31.28 |
| P_{g,F} | 0.6258 | 0.6248 | 0.6236 | 0.6288 | 0.6110 |
| [symbol] P_{g,F} | 0.0253 | 0.0243 | 0.0226 | 0.0268 | 0.0191 |
| S_{g} | 3.10 | 3.11 | 3.14 | 3.12 | 2.90 |
| Time period required | Less than | Less than | Less than | Less than | Less than |
| for melting glass | 15 minutes | 15 minutes | 15 minutes | 15 minutes | 15 minutes |
| raw materials | | | | | |

TABLE 3

| | Example 11 | Example 12 | Example 13 | Example 14 | Example 15 |
|---|---|---|---|---|---|
| SiO₂ | 3.02 | | 1.52 | | |
| P₂O₅ | 28.71 | 29.44 | 36.90 | 30.11 | 29.56 |
| B₂O₃ | 4.87 | 5.90 | 0.95 | | |
| Li₂O | | | | 2.59 | 2.86 |
| Na₂O | 9.15 | 7.91 | 13.89 | 8.08 | 8.17 |
| K₂O | 6.85 | 7.58 | 7.19 | 7.74 | 7.83 |
| BaO | 5.00 | 1.65 | 6.89 | 1.69 | 1.71 |
| ZnO | | 0.97 | 1.18 | 0.35 | 0.35 |
| Al₂O₃ | 0.75 | 0.65 | 1.17 | 0.67 | 0.68 |
| TiO₂ | 13.06 | 8.94 | 19.20 | 9.14 | 9.24 |
| Nb₂O₅ | 28.54 | 35.97 | 10.81 | 36.79 | 37.21 |
| ZrO₂ | | 0.95 | | 0.97 | |
| MgO | | | | | |
| CaO | | | | | |
| Y₂O₃ | | | | | 0.90 |
| La₂O₃ | | | | | |
| Gd₂O₃ | | | | | 1.44 |
| WO₃ | | | | 1.82 | |
| Sb₂O₃ | 0.05 | 0.04 | 0.30 | 0.05 | 0.05 |
| Total | 100 | 100 | 100 | 100 | 100 |
| P₂O₅ + B₂O₃ | 33.58 | 35.34 | 37.85 | 30.11 | 29.56 |
| B₂O₃/P₂O₅ | 0.169627 | 0.200408 | 0.25745 | 0 | 0 |
| TiO₂/P₂O₅ | 0.454894 | 0.303668 | 0.520325 | 0.303554 | 0.312585 |
| Nb₂O₅/P₂O₅ | 0.994079 | 1.221807 | 0.292954 | 1.221853 | 1.258796 |
| Li₂O + Na₂O +K₂O | 16.00 | 15.49 | 21.08 | 18.41 | 18.86 |
| n_{d} | 1.763416 | 1.771000 | 1.711032 | 1.793388 | 1.789582 |
| ν_{d} | 24.16 | 24.31 | 25.90 | 23.58 | 23.98 |
| P_{g,F} | 0.6285 | 0.6246 | 0.6302 | 0.6301 | 0.6295 |
| [symbol] P_{g,F} | 0.0247 | 0.0211 | 0.0293 | 0.0253 | 0.0254 |
| S_{g} | 3.17 | 3.23 | 3.08 | 3.32 | 3.32 |
| Time period required | Less than | Less than | Less than | Less than | Less than |
| for melting glass | 15 minutes | 15 minutes | 15 minutes | 15 minutes | 15 minutes |
| raw materials | | | | | |

TABLE 4

| | Example 16 | Example 17 | Example 18 | Example 19 |
|---|---|---|---|---|
| SiO₂ | | | | |
| P₂O₅ | 28.92 | 28.96 | 28.50 | 37.27 |
| B₂O₃ | | | | 8.82 |
| Li₂O | 1.05 | 1.05 | 0.35 | |
| Na₂O | 8.00 | 8.01 | 7.66 | 11.21 |
| K₂O | 7.67 | 7.68 | 7.55 | 12.34 |
| BaO | 1.67 | 1.67 | 1.65 | 2.09 |
| ZnO | 2.56 | 3.21 | 4.08 | 1.22 |
| Al₂O₃ | 4.63 | 3.84 | 5.35 | 0.83 |
| TiO₂ | 9.05 | 9.06 | 8.92 | 18.23 |
| Nb₂O₅ | 36.41 | 36.47 | 35.90 | 5.43 |
| ZrO₂ | | | | |
| MgO | | | | |
| CaO | | | | |
| Y₂O₃ | | | | |
| La₂O₃ | | | | |
| Gd₂O₃ | | | | |
| WO₃ | | | | 0.23 |
| Bi₂O₃ | | | | 2.27 |
| Sb₂O₃ | 0.04 | 0.05 | 0.04 | 0.06 |
| Total | 100 | 100 | 100 | 100 |
| P₂O₅ + B₂O₃ | 28.92 | 28.96 | 28.50 | 46.09 |
| B₂O₃/P₂O₅ | 0 | 0 | 0 | 0.236651 |
| TiO₂/P₂O₅ | 0.312932 | 0.312845 | 0.312982 | 0.489133 |
| Nb₂O₅/P₂O₅ | 1.258990 | 1.259323 | 1.259649 | 0.145694 |
| Li₂O + Na₂O +K₂O | 16.72 | 16.74 | 15.56 | 23.55 |
| n_{d} | 1.780420 | 1.784243 | 1.784119 | 1.665676 |
| ν_{d} | 24.22 | 24.03 | 24.03 | 28.40 |
| P_{g,F} | 0.6277 | 0.6291 | 0.6289 | 0.6242 |
| [symbol] P_{g,F} | 0.0240 | 0.0251 | 0.0249 | 0.0275 |
| S_{g} | 3.31 | 3.31 | 3.32 | 2.89 |
| Time period required | Less than | Less than | Less than | Less than |
| for melting glass | 15 minutes | 15 minutes | 15 minutes | 15 minutes |
| raw materials | | | | |

TABLE 5

| | Comparative | Comparative | Comparative | Comparative |
|---|---|---|---|---|
| | example 1 | example 2 | example 3 | example 4 |
| SiO₂ | 2.02 | 2.02 | | |
| P₂O₅ | 24.20 | 24.21 | 26.73 | 25.83 |
| B₂O₃ | 3.93 | 3.93 | | |
| Li₂O | | | | |
| Na₂O | 12.32 | 12.32 | 6.81 | 6.38 |
| K₂O | 7.08 | 7.08 | 7.39 | 7.45 |
| BaO | 5.99 | 5.99 | | |
| ZnO | 0.78 | 0.78 | 5.10 | 5.14 |
| Al₂O₃ | 1.03 | 1.03 | 8.44 | 9.30 |
| TiO₂ | 26.25 | 21.25 | 9.05 | 9.13 |
| Nb₂O₅ | 16.34 | 21.33 | 36.44 | 36.73 |
| ZrO₂ | | | | |
| MgO | | | | |
| CaO | | | | |
| Y₂O₃ | | | | |
| La₂O₃ | | | | |
| Gd₂O₃ | | | | |
| WO₃ | | | | |
| Sb₂O₃ | 0.06 | 0.06 | 0.04 | 0.04 |
| Total | 100 | 100 | 100 | 100 |
| P₂O₅ + B₂O₃ | 28.13 | 28.14 | 26.73 | 25.83 |
| B₂O₃/P₂O₅ | 0.162397 | 0.162330 | 0 | 0 |
| TiO₂/P₂O₅ | 1.084711 | 0.877736 | 0.338571 | 0.353465 |
| Nb₂O₅/P₂O₅ | 0.675207 | 0.881041 | 1.363262 | 1.42190 |
| Li₂O + Na₂O +K₂O | 19.40 | 19.40 | 14.20 | 13.83 |
| n_{d} | Unmeasureable | Unmeasureable | Unmeasureable | Unmeasureable |
| ν_{d} | Unmeasureable | Unmeasureable | Unmeasureable | Unmeasureable |
| P_{g,F} | Unmeasureable | Unmeasureable | Unmeasureable | Unmeasureable |
| [symbol] P_{g,F} | Unmeasureable | Unmeasureable | Unmeasureable | Unmeasureable |
| S_{g} | Unmeasureable | Unmeasureable | Unmeasureable | Unmeasureable |
| Time period required | Less than | Less than | Less than | Less than |
| for melting glass | 15 minutes | 15 minutes | 15 minutes | 15 minutes |
| raw materials | | | | |

It was confirmed that the optical glasses in the Examples were highly dispersive but yet small in specific gravity, and had large values for ΔP_{g, F} and P_{g, F}. Further, the time period required for melting the glass raw materials for producing the glass was short, and thus excellent production efficiency was confirmed. Note that, due to devitrification, it was impossible to measure the physical properties in Comparative Examples 1 to 4.

### REFERENCE SIGNS LIST

1 Imaging device
101 Camera body
102 Lens barrel
103 Lens
104 Sensor chip
105 Glass substrate
106 Multi-chip module
2 Multi-photon microscope
201 Pulse laser device
202 Pulse division device
203 Beam adjustment unit
204, 205, 212 Dichroic mirror
206 Objective lens
207, 211, 213 Fluorescence detection unit
208 Condensing lens
209 Pinhole
210 Image forming lens
S Sample
CAM Imaging device
WL Photographing lens
EF Auxiliary light emitting unit
LM Liquid crystal monitor
B1 Release button
B2 Function button

What is claimed is:

1. An optical glass comprising: by mass %,
24.5% to 41% of a P₂O₅ content;
6% to 17% of an Na₂O content;
5% to 15% of a K₂O content;
over 0% to 7% or less of an Al₂O₃ content;
8% to 21% of a TiO₂ content; and
5% to 38% of an Nb₂O₅ content, wherein
the optical glass has a partial dispersion ratio (P_{g, F}) of 0.634 or less.

2. The optical glass according to claim 1, further comprising: by mass %,
0% to 3.5% of an SiO₂ content;
0% to 10% of a B₂O₃ content;
0% to 5% of a Bi₂O₃ content;
0% to 2% of an MgO content;
0% to 3.5% of an Li₂O content;
0% to 9.5% of a CaO content;
0% to 9% of a BaO content;
0% to 1.5% of an SrO content;
0% to 5% of a ZnO content;
0% to 6% of a ZrO₂ content;
0% to 1.5% of a Y₂O₃ content;
0% to 1.5% of an La₂O₃ content;
0% to 2% of a Gd₂O₃ content;
0% to 3% of a WO₃ content; and
0% to 0.4% of an Sb₂O₃ content.

3. The optical glass according to claim 1, wherein
total content rate of P₂O₅ and B₂O₃ (P₂O₅+B₂O₃) is from 28% to 43%.

4. The optical glass according to claim 1, wherein
in a mass % basis, a ratio of the B₂O₃ content to the P₂O₅ content (B₂O₃/P₂O₅) is from 0 to 0.24.

5. The optical glass according to claim 1, wherein
in a mass % basis, a ratio of the TiO₂ content to the P₂O₅ content (TiO₂/P₂O₅) is from 0.3 to 0.7.

6. The optical glass according to claim 1, wherein
in a mass % basis, a ratio of the Nb₂O₅ content to the P₂O₅ content (Nb₂O₅/P₂O₅) is from 0.1 to 1.3.

7. The optical glass according to claim 1, wherein
by mass %, a sum of contents including Li₂O, Na₂O, and K₂O (Li₂O+Na₂O+K₂O) is from 14% to 25% or less.

8. The optical glass according to claim 1, wherein
a refractive index (n_{d}) with respect to a d-line is within a range from 1.66 to 1.81, and
an abbe number (ν_{d}) is within a range from 22 to 32.

9. The optical glass according to claim 1, wherein
specific gravity (S_{g}) is from 2.8 to 3.4.

10. The optical glass according to claim 1, wherein
ΔP_{g, F} is from 0.0190 to 0.0320.

11. The optical glass according to claim 1, wherein
when 50 g of raw materials of the optical glass are heated at a temperature from 1,100 degrees Celsius to 1,250 degrees Celsius, a time period required for melting the raw materials is less than 15 minutes.

12. An optical element using the optical glass according to claim 1.

13. An optical system comprising the optical element according to claim 12.

14. An interchangeable lens comprising the optical system according to claim 13.

15. An optical device comprising the optical system according to claim 13.
